(19) United States
(12) Patent Application Publication
(10) Pub. No.: US 2017/0091342 A1
(43) Pub. Date: Mar. 30, 2017

(54) TECHNOLOGIES FOR AUTOMATIC PARTITIONING OF LARGE GRAPHS

(71) Applicant: Intel Corporation, Santa Clara, CA (US)

(72) Inventors: Lawrence J. Sun, Beaverton, OR (US); Vasanth R. Tovinkere, Portland, OR (US)

(21) Appl. No.: 14/866,190

(22) Filed: Sep. 25, 2015

(51) Int. Cl. G06F 17/30

(52) U.S. Cl. CPC G06F 17/30958; G06F 17/30377; G06F 17/30336

(57) ABSTRACT

Technologies for automatic graph partitioning include a computing device that approximates a vertex centrality weight for each vertex of a graph and then approximates, based on the approximate vertex centrality weight, an approximate edge centrality value for each edge of the graph. The computing device may repeatedly delete an edge having the highest edge centrality value and test if the graph has been disconnected. If the graph is disconnected, the computing device calculates a cluster quality metric. If the cluster quality does not decrease, the computing device realizes a new clustering of the graph based on the disconnected partitions. If the cluster quality metric decreases, the computing device reintroduces a deleted edge. The computing device recalculates the approximate vertex centrality weights and edge centrality values after reintroducing a deleted edge, deleting a predefined number of edges, or realizing a new clustering. Other embodiments are described and claimed.

### BACKGROUND

In a data-flow programming paradigm, computer programs may be described as data-flow graphs. To perform performance analysis of data-flow programs, the associated data-flow graph may be partitioned into smaller, independent graphs that may be analyzed individually. For example, different partitions of a graph may have different performance characteristics and thus may benefit from different performance solutions.

Determining an optimal graph partitioning is typically an NP-hard problem, and thus graph partitioning algorithms typically sacrifice either speed or accuracy to obtain satisfactory results. Typical graph partitioning algorithms utilize global properties of the graph. For example, eigenvectors of the Laplacian matrix or the minimum cut of the graph may be used to partition the graph. As another example, graph partitioning may be performed by continually deleting the edge of the graph with the largest edge centrality to disconnect the graph and find the partitions. Typical graph partitioning algorithms such as these do not scale well to large graph sizes.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing device for automatic graph partitioning;

FIG. 2 is a simplified block diagram of at least one embodiment of an environment of the computing device of FIG. 1;

FIGS. 3A and 3B are a simplified flow diagram of at least one embodiment of a method for automatic graph partitioning that may be executed by the computing device of FIGS. 1 and 2;

FIGS. 4A to 4C are schematic diagrams of illustrative graphs that may be analyzed by the method of FIG. 3;

FIG. 5 is a simplified flow diagram of at least one embodiment of a method for approximating vertex centrality that may be executed by the computing device of FIGS. 1 and 2; and

FIG. 6 is a simplified flow diagram of at least one embodiment of a method for approximating edge centrality that may be executed by the computing device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

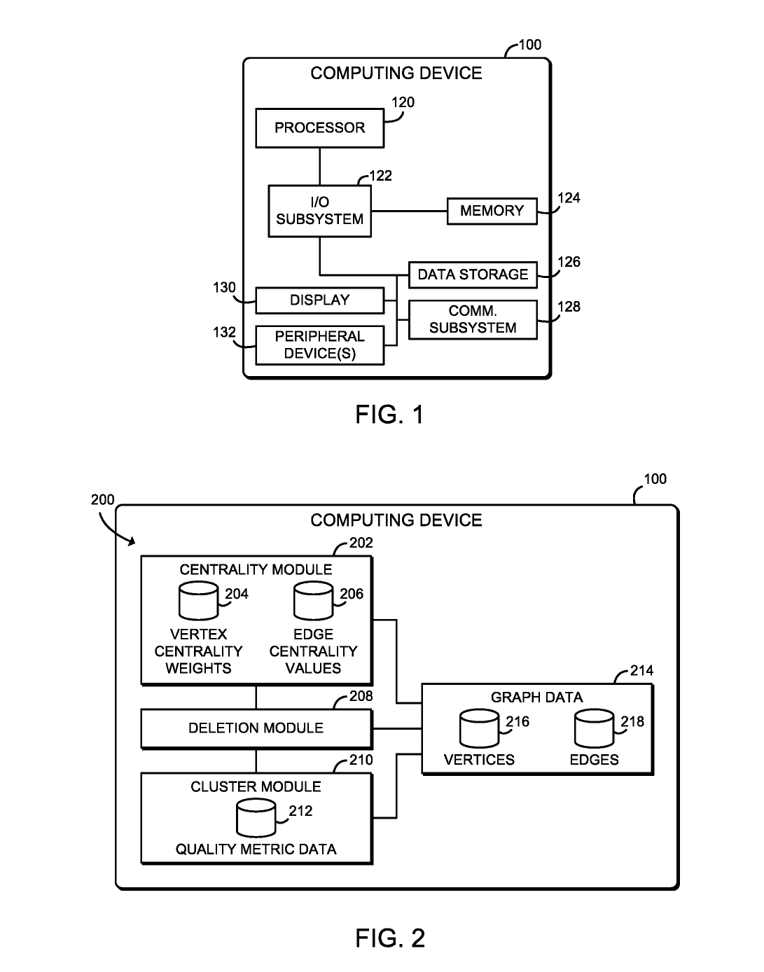

Referring now to FIG. 1, an illustrative computing device 100 for automatic partitioning of a computer program graph includes a processor 120, an I/O subsystem 122, a memory 124, and a data storage device 126. In use, as described below, the computing device 100 is configured to calculate approximate vertex centrality weights and approximate edge centrality values for a graph representing a computer program using iterative sampling algorithms. The computing device 100 deletes the edge with the highest edge centrality value in an attempt to disconnect partitions within the graph. The computing device 100 may delete multiple edges before recalculating approximate vertex centrality weights and edge centrality values. When a clustering of the graph is identified, the computing device 100 calculates one or more cluster quality metrics. If a cluster quality metric decreases, the computing device 100 may backtrack by reintroducing a deleted edge to the graph and recalculating approximate vertex centrality weights and edge centrality values. After a threshold number of backtracks, the computing device 100 may ignore the cluster quality metric and proceed without backtracking. Optimal clusterings may be identified as clusterings with the highest cluster quality metric. The automatic graph partitioning performed by the computing device 100 may scale well to large graph sizes, particularly to large sparse graphs representing data-flow oriented computer programs. Thus, the computing device 100 may perform automatic graph partitioning with sufficient performance for many practical uses, including performance analysis of large data-flow graphs, dispatching work in parallel, semantic analysis of large graphs, or other graph analysis tasks.

The computing device 100 may be embodied as any type of device capable of performing the functions described herein. For example, the computing device 100 may be embodied as, without limitation, a computer, a workstation, a server computer, a laptop computer, a notebook computer, a tablet computer, a smartphone, a mobile computing device, a desktop computer, a distributed computing system, a multiprocessor system, a consumer electronic device, a smart appliance, and/or any other computing device capable of analyzing software code segments. As shown in FIG. 1, the illustrative computing device 100 includes the processor 120, the I/O subsystem 122, the memory 124, and the data storage device 126. Of course, the computing device 100 may include other or additional components, such as those commonly found in a workstation (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. For example, the processor may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the computing device 100 such operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the computing device 100. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the computing device 100, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The data storage device 126 may store, for example, one or more graphs to be analyzed.

The computing device 100 may also include a communication subsystem 128, which may be embodied as any communication circuit, device, or collection thereof, capable of enabling communications between the computing device 100 and other remote devices over a computer network (not shown). The communication subsystem 128 may be configured to use any one or more communication technology (e.g., wired or wireless communications) and associated protocols (e.g., Ethernet, Bluetooth®, Wi-Fi®, WiMAX, etc.) to effect such communication.

Additionally, the computing device 100 may include a display 130 that may be embodied as any type of display capable of displaying digital information such as a liquid crystal display (LCD), a light emitting diode (LED), a plasma display, a cathode ray tube (CRT), or other type of display device. In some embodiments, the computing device 100 may also include one or more peripheral devices 132. The peripheral devices 132 may include any number of additional input/output devices, interface devices, and/or other peripheral devices.

Referring now to FIG. 2, in the illustrative embodiment, the computing device 100 establishes an environment 200 during operation. The illustrative embodiment 200 includes a centrality module 202, a deletion module 208, and a cluster module 210. The various modules of the environment 200 may be embodied as hardware, firmware, software, or a combination thereof. As such, in some embodiments, one or more of the modules of the environment 200 may be embodied as circuitry or collection of electrical devices (e.g., centrality circuitry 202, deletion circuitry 208, and/or cluster circuitry 210). It should be appreciated that, in such embodiments, one or more of the centrality circuitry 202, the deletion circuitry 208, and/or the cluster circuitry 210 may form a portion of one or more of the processor 120, the I/O subsystem 122, the memory 124, the data storage 126, the communication subsystem 128, and/or other components of the computing device 100. Additionally, in some embodiments, one or more of the illustrative modules may form a portion of another module and/or one or more of the illustrative modules may be independent of one another.

As shown, the environment 200 includes graph data 214, which may represent a data flow graph 214 or other graph representing a computer program that is to be analyzed. The illustrative graph data 214 includes vertices 216 and edges 218. The centrality module 202 is configured to calculate approximate vertex centrality weights 204 for each vertex 216 of the graph 214. The centrality module 202 is further configured to calculate approximate edge centrality values 206 for each edge 218 of the graph 214 based on the vertex centrality weights 204. As described further below, the centrality module 202 is further configured recalculate the approximate vertex centrality weights 204 and the approximate edge centrality values 206 if a threshold number of edges 218 have been deleted from the graph 214, if a deleted edge 218 is reintroduced into the graph 214, or if a new clustering of the graph 214 is realized.

The deletion module 208 is configured to delete an edge 218 of the graph 214 having the largest approximate edge centrality value 206 of the graph 214. The deletion module 208 is further configured to determine whether the former endpoints 216 of the deleted edge 218 are connected in the graph 214 subsequent to deleting the edge 218. The deletion module 208 is further configured to continue deleting edges 218 of the graph 214 having the highest edge centrality value 206 until the endpoints 216 of the deleted edge 218 are no longer connected or until a threshold number of edges 218 have been deleted.

The cluster module 210 is configured to compute one or more cluster quality metrics 212 for the graph 214 after it is determined the former endpoints 216 of a deleted edge 218 are not connected in the graph 214. As described below, the cluster quality metrics data 212 may include a modularity metric and/or a modified cluster path length. The cluster module 210 is further configured to determine whether a cluster quality metric 212 has decreased in response to determining that the former endpoints 216 of a deleted edge 218 are not connected in the graph 214 214. If the cluster quality metric 212 has not decreased, then a new clustering of the graph 214 has been realized. The cluster module 210 is configured to record the current clustering and the associated cluster quality metric 212. When a sufficient number of clusterings have been recorded, the cluster module 210 is configured to identify an optimal clustering of the graph 214 for each of the associated cluster quality metrics 212. If it is determined that the cluster quality metric 212 has decreased, the deletion module 208 is configured to reintroduce the deleted edge 218 into the graph 214 and increment a backtrack counter. If a predetermined maximum backtrack threshold is exceeded, the cluster module 210 may be configured to record the current clustering and the associated cluster quality metric 212 even if the cluster quality metric 212 has decreased.

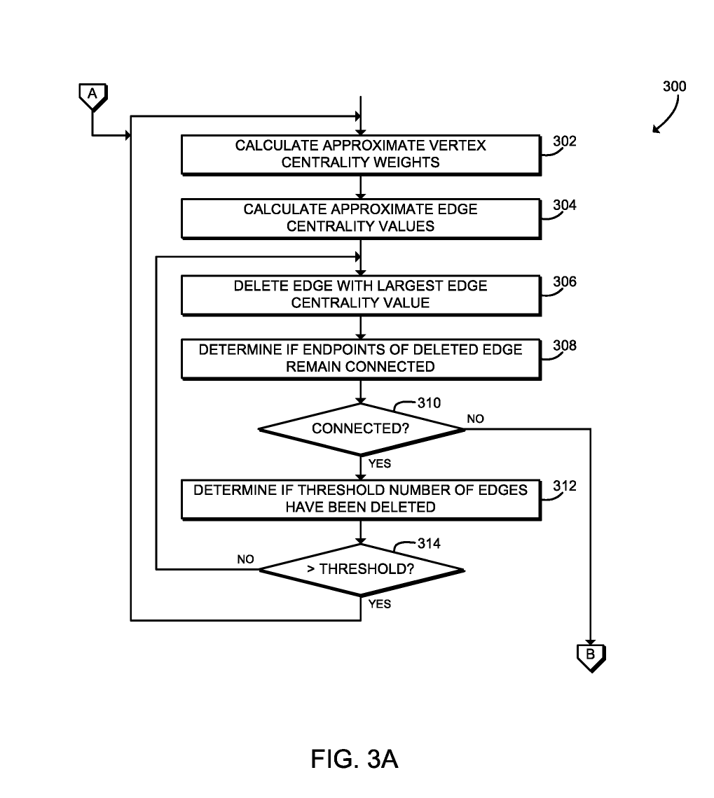

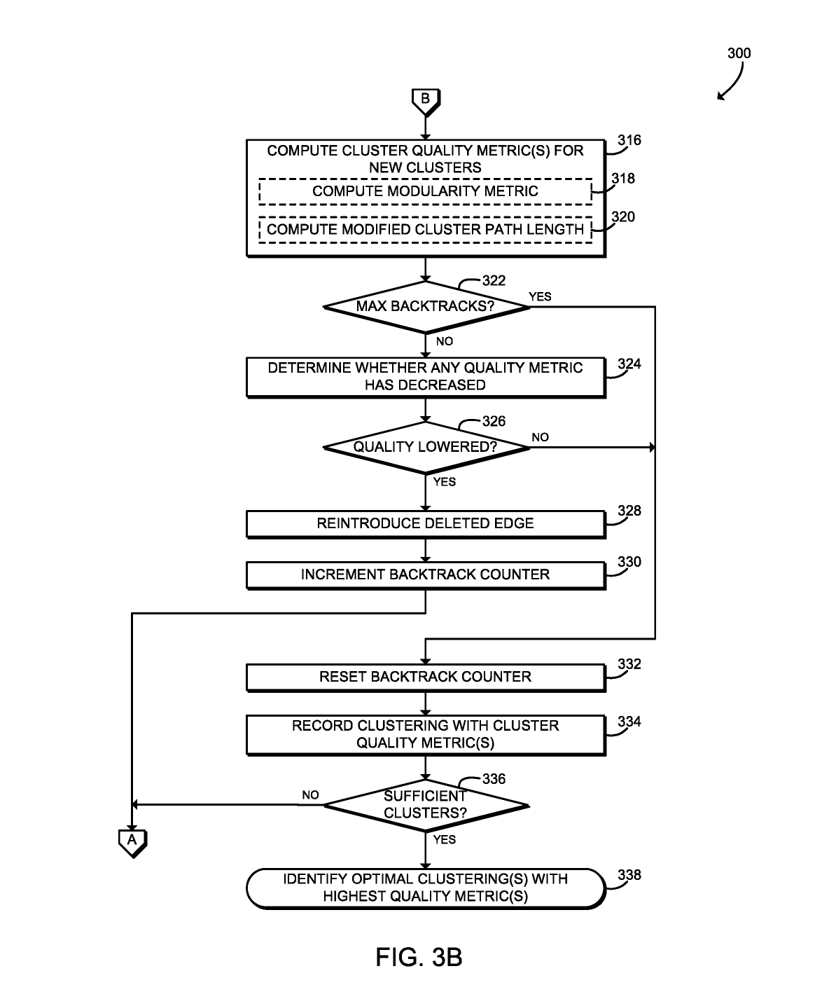

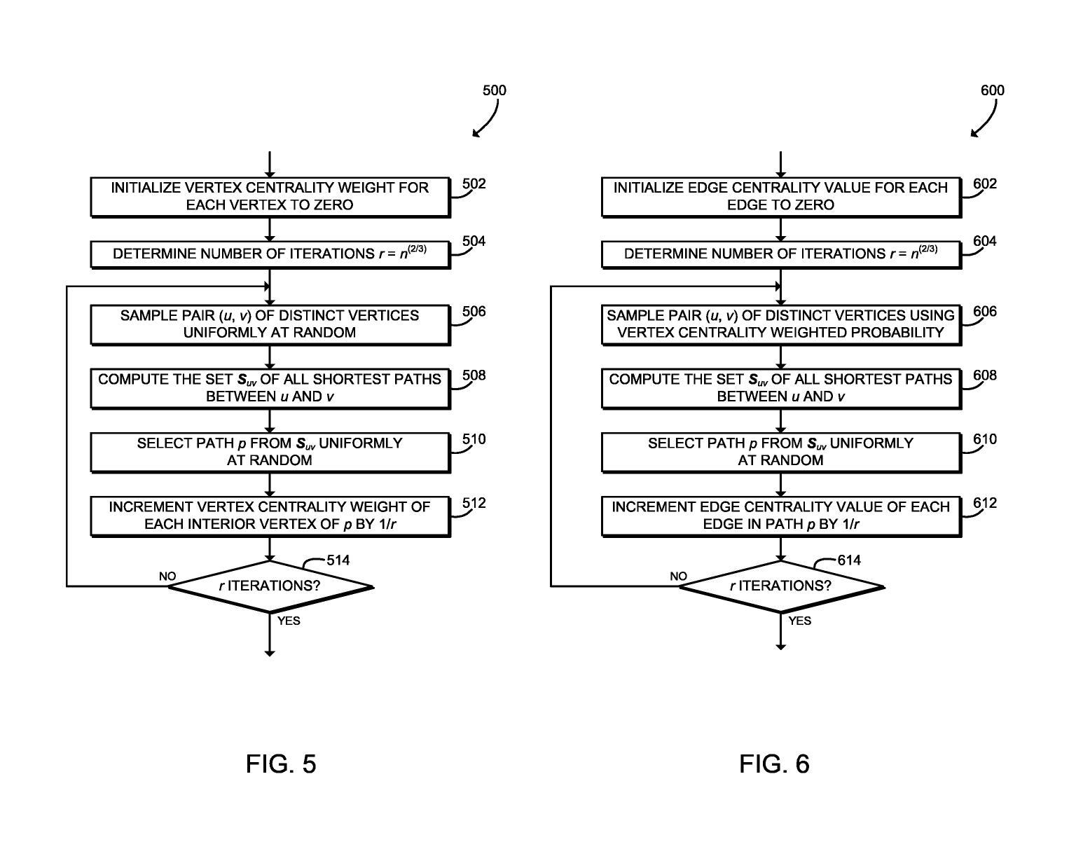

Referring now to FIGS. 3A and 3B, in use, the computing device 100 may execute a method 300 for automatic partitioning of a computer program graph. The method 300 begins in block 302, in which the computing device 100 calculates approximate vertex centrality weights 204 for each vertex 216 in a graph 214. As described above, the graph 214 may be embodied as, for example, a data-flow graph that represents a computer program. Vertex centrality measures the number of shortest paths between all vertices 216 that include a particular vertex 216. The vertices 216 that are included in more shortest paths are typically more central to the graph 214 and thus may indicate boundaries between partitions in the graph 214. To approximate the vertex centrality weights 204, the computing device 100 may perform an iterative sampling algorithm as described below in connection with FIG. 5.

In block 304, the computing device 100 calculates approximate edge centrality values 206 for each edge 218 in the graph 214. The computing device 100 calculates the approximate edge centrality based on the vertex centrality weights 204 determined as described above in connection with block 302. Edge centrality measures the number of shortest paths between all vertices 216 that include a particular edge 218. The edges 218 that are included in more shortest paths are typically more central to the graph 214 and thus may indicate boundaries between partitions in the graph 214. To approximate the edge centrality values 206, the computing device 100 may perform an iterative sampling algorithm as described below in connection with FIG. 6.

In block 306, the computing device 100 deletes the edge 218 with the highest edge centrality value 206 from the graph 214. The computing device 100 may record the deleted edge 218 so that the deleted edge 218 may be reintroduced into the graph 214 (i.e., “undeleted”) as described further below. In block 308, the computing device 100 determines if the endpoints 216 of the deleted edge 218 remain connected in the graph 214. The computing device 100 may, for example, determine if any path exists in the graph 214 between the vertices 216 that were the endpoints of the deleted edge 218. In some embodiments, the computing device 100 may start a breadth-first search of the graph 214 from one of the endpoints 216 and determine whether the other endpoint 216 is reachable. In block 310, the computing device 100 checks whether the endpoints 216 of the deleted edge 218 remain connected in the graph 214. If not, the method 300 branches ahead to block 316, shown in FIG. 3B and described further below. If the endpoints 216 of the deleted edge 218 remain connected, the method 300 advances to block 312.

In block 312, the computing device 100 determines if a threshold number of edges 218 have been deleted from the graph 214. For example, the computing device 100 may check a counter that is incremented after every deletion of an edge 218. In the illustrative embodiment, the threshold number of edges is five edges, which provides the greatest speed increase to the algorithm without causing excessive backtracking due to deleting too many edges 218 prior to recalculating the edge centrality values. In block 314, the computing device 100 checks whether the threshold number of deletions has been exceeded. If not, the method 300 loops back to block 306 to continue deleting the edge 218 with the largest edge centrality value 206. If the threshold has been exceeded, the method 300 loops back to block 302 to recalculate the approximate vertex centrality weights 204 and the approximate edge centrality values 206. The computing device 100 may also reset an edge deletion counter or otherwise reset the number of edges 218 that have been deleted.

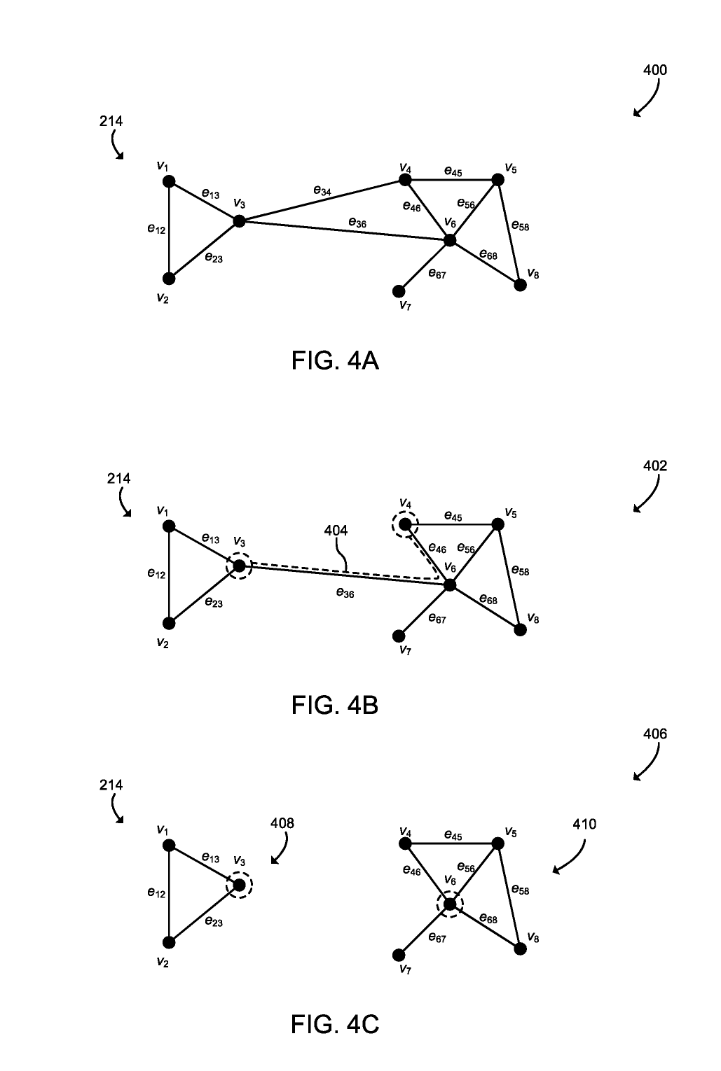

Referring now to FIG. 4A, schematic diagram 400 illustrates one potential embodiment of a graph 214. The illustrative graph 214 includes eight vertices 216, labeled v₁ to v₈. In the illustrative diagram 400, the edges 218 are labeled eᵢⱼ, where i and j identify the endpoints of the labeled edge (i.e., the vertices 216 that are connected by the edge 218). For example, the edge e₁₂ connects vertices v₁ and v₂, the edge e₁₃ connects vertices v₁ and v₃, and so on. In the illustrative embodiment, the computing device 100 may determine that the edge e₃₄ has the highest edge centrality value 206. Referring now to FIG. 4B, schematic diagram 402 illustrates the graph 214 after the edge e₃₄ has been deleted. The endpoints of the deleted edge e₃₄ are the vertices v₃ and V_{4′} As shown, a path 404 exists between the vertices v₃ and V_{4′} Thus, after deletion, the former endpoints of the edge e₃₄ remain connected in the graph 214. After deletion of the edge e₃₄, the computing device 100 may determine that the edge e₃₆ has the highest edge centrality value 206 of the edges 218 remaining in the graph 214. Referring now to FIG. 4C, schematic diagram 406 illustrates the graph 214 after the edge e₃₆ has been deleted. The endpoints of the deleted edge e₃₆ are the vertices v₃ and v₆. As shown in FIG. 4C, no path exists between the vertices v₃ and v₆. Thus, after deletion of the edge e₃₆, the graph 214 has been disconnected into two partitions 408, 410.

Referring back FIGS. 3A and 3B, as described above in connection with block 310, if the endpoints 216 of the deleted edge 218 are not connected, the method 300 branches to block 316, shown in FIG. 3B. Once the endpoints 216 of the deleted edge 218 are no longer connected in the graph 214, a new clustering of the graph 214 has been identified. The two disjoint portions of the graph 214 connected to each endpoint 216 of the deleted edge 218 are the new clusters, which may replace a previously-identified cluster that included the two endpoints 216.

In block 316, the computing device 100 computes one or more cluster quality metrics 212 for the graph 214. The cluster quality metric 212 may be embodied as any measure indicating a characteristic of the current clustering within the graph 214, such as connectedness, compactness, or other characteristics. In some embodiments, in block 318, the computing device 100 may compute a modularity metric Q for the graph 214. The computing device 100 may compute the modularity metric Q using Equation 1, as shown below. To calculate Q, the computing device 100 constructs a k×k matrix e, where k is the number of clusters or partitions found in the graph 214. Each element eᵢⱼ of e is the fraction of all edges 218 in the graph 214 that link vertices 216 in the cluster i to vertices 216 in the cluster j. The values of the matrix e are determined based on the original graph 214, prior to any deletions of edges 218. The row sums aᵢ are defined as aᵢ=Σⱼeᵢⱼ, and represent the fraction of all edges 218 that connect to vertices 216 in the cluster i. As shown in Equation 1, the modularity measure Q equals the trace of the matrix e minus the sum of the elements of the matrix e². Values of Q close to zero indicate that the number of within-cluster edges is no better than would be expected with random connections between vertices, and thus may indicate poor clustering. Values of Q close to one, which is the maximum value, may indicate good clustering.

$$Q = {\sum }_{i} ( {e}_{ii} - {a}_{i}^{2} ) = Tre - ‖ {e}^{2} ‖ \qquad ( 1 )$$

In some embodiments, in block 320 the computing device 100 may calculate a modified cluster path length metric for the graph 214. The modified cluster path metric calculated by the computing device 100 maximizes at reasonable cluster numbers and sizes for large graphs and peaks for similar clusterings as compared to the modularity metric Q. Similar to the modularity metric Q, higher values of the modified cluster length indicate better clustering. As shown in Equation 2, the modified cluster path length M is equal to a plus component M⁺ minus four times a minus component M⁻.

M=M⁺−4M⁻ (2)

The plus component M⁺ is calculated as shown in Equation 3. The term nᵢ of Equation 3 represents the number of vertices 216 in a cluster i, and the term n represents the number of vertices 216 in the graph 214. Thus, the plus component M⁺ equals the sum of average distance between vertices 216 in the graph 214 over the average distance between vertices 216 in each cluster, weighted by the relative number of vertices 216 in each cluster.

$${M}^{+} = \frac{1}{n} {\sum }_{i = 1}^{k} \frac{{n}_{i} \cdot Average Distance Between Vertices in Graph}{Average Distance Between Vertices in Cluster i} \qquad ( 3 )$$

The minus component M⁻ is calculated as shown in Equation 4. As shown, the minus component M⁻ includes edge density, which may be calculated as shown in Equation 5. The edge density represents the ratio of the number of edges 218 in the graph 214 in relation to the maximum potential number of edges that could be included in the graph 214. Including the edge density in the minus component M⁻ may prevent over-clustering for sparse graphs 214.

$$\begin{matrix}{M}^{-} = \frac{1}{k ( k - 1 )} {\sum }_{{i , j = 1}_{i \neq j}}^{k} \frac{Edges Between Clusters i , j}{{n}_{i} \cdot {n}_{j} \cdot Edge Density} & ( 4 ) \\ Edge Density = \frac{Number of Edges}{n ( n - 1 )} & ( 5 )\end{matrix}$$

After calculating the cluster quality metrics 212, in block 322 the computing device 100 determines whether a maximum number of backtracks has been exceeded. As described further below, in certain circumstances the computing device 100 may backtrack by reintroducing a deleted edge 218 to the graph 214. Each time the computing device 100 reintroduces a deleted edge 218, the computing device 100 may increment a backtrack counter. Thus, in block 322 the computing device 100 may compare the backtrack counter to a predetermined threshold number of backtracks. In the illustrative embodiment, the maximum number of backtracks is 10, which provides a satisfactory balance of execution speed and cluster quality. A larger maximum number of backtracks may improve cluster quality while reducing execution speed. If the maximum number of backtracks is exceeded, the method 300 branches ahead to block 332, described below. If the maximum number of backtracks is not exceeded, the method 300 advances to block 324.

In block 324, the computing device 100 determines whether any of the cluster quality metrics 212 has decreased significantly as a result of deleting the edges 218. The cluster quality metrics 212 may be initialized to a minimum value, such as zero, and the computing device 100 may maintain previous values of the cluster quality metrics 212 for previous clusterings of the graph 214. A decreasing cluster quality metric 212 indicates that the current clustering of the graph 214 (i.e., splitting a previously identified cluster into two newly identified clusters) has caused a drop in cluster quality rather than an increase in cluster quality. The computing device 100 may determine whether a drop in the cluster quality metric 212 has exceeded a predefined threshold. If a cluster quality metric 212 has not decreased significantly, the method 300 branches ahead to block 332, described below. If a cluster quality metric 212 has decreased significantly, the method 300 advances to block 328.

In block 328, the computing device 100 reintroduces the most recently deleted edge 218 to the graph 214. For example, referring to FIG. 4C, if the computing device 100 determines that a cluster quality metric 212 associated with the clusters 408, 410 has dropped, the computing device 100 may reintroduce the edge e₃₆, resulting in the graph 214 as shown in FIG. 4B. Referring back to FIG. 3B, in block 330, after reintroducing the deleted edge 218 the computing device 100 increments the backtrack counter. As described above in connection with block 322, if the maximum number of backtracks is exceeded, the method 300 skips ahead to block 332 without determining whether the quality metric has decreased. Thus, by attempting a maximum number of backtracks and then skipping ahead, the method 300 may continue to make progress even if the cluster quality metric 212 continues to decrease after multiple backtracks. After incrementing the backtrack counter, the method 300 loops back to block 302 shown in FIG. 3A to recalculate the approximate vertex centrality weights 204 and the edge centrality values 206.

Referring back to blocks 322, 326, if the cluster quality metric 212 has not decreased—or if the maximum number of backtracks has been exceeded—the method 300 branches ahead to block 332. In block 332, the computing device 100 resets the backtrack counter, indicating that a new clustering has been realized. In block 334, the computing device 100 records the current clustering of the graph 214 as well as the associated cluster quality metrics 212. The computing device 100 may record, for example, the vertices 216 included in each identified cluster within the graph 214. In block 336, the computing device 100 determines whether a sufficient number of clusterings have been recorded. For example, the computing device 100 may determine whether the cluster quality metrics 212 have decreased for several iterations, leveled off, or otherwise stabilized. As another example, the computing device 100 may continue finding clusters and recording clusterings until a predefined number of clusters has been identified, or until the identified clusters have a predefined size. If sufficient clusterings have not been recorded, the method 300 loops back to block 302 shown in FIG. 3A to recalculate the approximate vertex centrality weights 204 and the edge centrality values 206. If sufficient clusterings have been recorded, the method 300 advances to block 338.

In block 338, the computing device 100 identifies optimal clusterings of the graph 214 as the clusterings having the highest associated cluster quality metrics 212. As described above, each clustering may identify the vertices 216 of the graph 214 that are included in each cluster. The computing device 100 may identify an optimal clustering for each cluster quality metric 212. For example, in the illustrative embodiment, the computing device 100 may identify two optimal clusterings: one clustering for the modularity metric Q and another clustering for the modified cluster path length M. For many graphs 214, the optimal clusterings for each of the cluster quality metrics 212 may be the same.

After identifying optimal clustering, the method 300 is completed. The computing device 100 may use the clusterings identified using the method 300 to perform additional analysis of the graph 214. For a data-flow graph 214, breaking the graph 214 into related subsets may enable further understanding, analyzing, and solving of performance problems. For example, identifying partitions of the graph 214 may allow performance analysis of large data-flow and dependence graphs executed by parallel runtimes. As another example, identifying partitions of the graph 214 may allow large graphs to be partitioned and then distributed across multiple machines or other computing devices. Identifying partitions of the graph 214 may also allow semantic analysis of large graphs and partitioning large graphs into groups with similar characteristics.

Referring now to FIG. 5, in use, the computing device 100 may execute a method 500 for approximating vertex centrality. As described above, the method 500 may be executed in connection with block 302 of FIG. 3. The method 500 begins in block 502, in which the computing device 100 initializes to zero the vertex centrality weight 204 for each vertex 216 in the graph 214. In block 504, the computing device 100 determines a total number of iterations r to process. The number of iterations r is equal to

$${n}^{\frac{2}{3}} ,$$

that is, the number of vertices 216 in the graph 214 to the two-thirds power. This number of iterations r is selected to provide results with a satisfactorily low expected error compared to the exact betweenness centrality values for the vertices 216. For example, referring to FIG. 4A, the graph 214 includes eight vertices 216. Thus, the number of iterations r for the illustrative graph 214 may be four.

In block 506, the computing device 100 samples a pair (u, v) of distinct vertices 216 within the graph 214. The computing device 100 selects the vertices 216 uniformly at random. In block 508, the computing device 100 computes the set Sᵤᵥ of all shortest paths between u and v in the graph 214. For example, referring again to FIG. 4A, the computing device 100 may select the vertices v₂ and v₅ at random. In that example, the set Sᵤᵥ of all shortest paths between v₂ and v₅ may include a path p₁ including the vertices (v₂, v₃, v₄, v₅) and a path p₂ including the vertices (v₂, v₃, v₆, v₅).

In block 510, the computing device 100 selects a path p from the set Sᵤᵥ uniformly at random. In block 512, the computing device 100 increments the vertex centrality weight 204 of each interior vertex 216 of the selected path p by

$$\frac{1}{r} .$$

For example, referring again to the FIG. 4A, for the set Sᵤᵥ of all shortest paths between v₂ and v₅, the computing device 100 may randomly select the path p including the vertices (v₂, v₃, v₄, v₅). In that example, the interior vertices 216 of the path p are the vertices (v₃, v₄). Thus, in the illustrative example, the computing device 100 may increment the vertex centrality weight 204 of each interior vertex (v₃, v₄) by

$$\frac{1}{r} ,$$

which equals 0.25 in the illustrative embodiment.

In block 514, the computing device 100 determines whether r iterations have been processed. If not, the method 500 loops back to block 506 to sample another pair of distinct vertices 216. If r iterations have been processed, the method 500 is completed, and approximate vertex centrality weights 204 have been calculated for the graph 214.

Referring now to FIG. 6, in use, the computing device 100 may execute a method 600 for approximating edge centrality. As described above, the method 600 may be executed in connection with block 304 of FIG. 3. The method 600 begins in block 602, in which the computing device 100 initializes to zero the edge centrality value 206 for each edge 218 in the graph 214. In block 604, the computing device 100 determines a total number of iterations r to process. The number of iterations r is equal to

$${n}^{\frac{2}{3}} ,$$

that is, the number of vertices 216 in the graph 214 to the two-thirds power. For example, referring to FIG. 4A, the graph 214 includes eight vertices 216. Thus, the number of iterations r for the illustrative graph 214 may be four.

In block 606, the computing device 100 samples a pair (u, v,) of distinct vertices 216 within the graph 214. The computing device 100 selects the vertices u, v with a probability that is weighted according to the vertex centrality weights 204 associated with the vertices 216. In other words, vertices 216 with a higher associated vertex centrality weight 204 are more likely to be sampled. Thus, unlike for the approximation of the vertex centrality weights 204 described above in connection with FIG. 5, the pair of vertices u, v are not selected uniformly at random. In block 608, the computing device 100 computes the set Sᵤᵥ of all shortest paths between u and v in the graph 214. For example, referring again to FIG. 4A, the computing device 100 may select the vertices v₂ and v₅. In that example, the set Sᵤᵥ of all shortest paths between v₂ and v₅ may include a path p₁ including the vertices (v₂, v₃, v₄, v₅) and a path p₂ including the vertices (v₂, v₃, v₆, v₅).

In block 610, the computing device 100 selects a path p from the set Sᵤᵥ uniformly at random. In block 612, the computing device 100 increments the edge centrality value 206 of each edge 218 in the selected path p by

$$\frac{1}{r} .$$

For example, referring again to the FIG. 4A, for the set Sᵤᵥ of all shortest paths between v₂ and v₅, the computing device 100 may randomly select the path p including the vertices (v₂, v₃, v₄, v₅). In that example, the edges of the selected path p are the edges (e₂₃, e₃₄, e₄₅). Thus, in the illustrative example, the computing device 100 may increment the edge centrality value 206 of each edge (e₂₃, e₃₄, e₄₅) by

$$\frac{1}{r} ,$$

which equals 0.25 in the illustrative embodiment.

In block 614, the computing device 100 determines whether r iterations have been processed. If not, the method 600 loops back to block 606 to sample another pair of distinct vertices 216. If r iterations have been processed, the method 600 is completed, and approximate edge centrality values 206 have been calculated for the graph 214.

It should be appreciated that, in some embodiments, any one or more of the methods 300, 500, and/or 600 may be embodied as various instructions stored on a computer-readable media, which may be executed by the processor 120, a peripheral device 132, and/or other components of the computing device 100 to cause the computing device 100 to perform the corresponding method 300, 500, and/or 600. The computer-readable media may be embodied as any type of media capable of being read by the computing device 100 including, but not limited to, the memory 124, the data storage 126, a local memory of the processor 120, other memory or data storage devices of the computing device 100, portable media readable by a peripheral device 132 of the computing device 100, and/or other media.

### EXAMPLES

Illustrative examples of the technologies disclosed herein are provided below. An embodiment of the technologies may include any one or more, and any combination of, the examples described below.

Example 1 includes a computing device for automatic graph partitioning, the computing device comprising centrality circuitry to (i) calculate an approximate vertex centrality weight for each vertex of a graph and (ii) calculate, based on the approximate vertex centrality weight for each vertex of the graph, an approximate edge centrality value for each edge of the graph; deletion circuitry to (i) delete a first edge of the graph, wherein the first edge connects a first vertex and a second vertex, and wherein the first edge has a largest approximate edge centrality value of the edges of the graph and (ii) determine whether the first vertex and the second vertex are connected in the graph subsequent to deletion of the first edge; and cluster circuitry to compute a cluster quality metric for the graph in response to a determination that the first vertex and the second vertex are not connected in the graph subsequent to deletion of the first edge.

Example 2 includes the subject matter of Example 1, and wherein the deletion circuitry is further to (i) determine whether a threshold number of edges have been deleted in response to a determination that the first vertex and the second vertex remain connected in the graph and (ii) delete a second edge of the graph in response to a determination that the threshold number of edges have not been deleted, wherein the second edge has a largest approximate edge centrality value of the edges remaining in the graph; and the centrality circuitry is further to recalculate an approximate vertex centrality weight for each vertex of the graph in response to a determination that the threshold number of edges have been deleted.

Example 3 includes the subject matter of any of Examples 1 and 2, and wherein the threshold number of edges comprises five edges.

Example 4 includes the subject matter of any of Examples 1-3, and wherein the cluster circuitry is further to (i) determine whether the cluster quality metric has decreased in response to deletion of the first edge of the graph and (ii) record a current clustering of the graph and the cluster quality metric in response to a determination the cluster quality metric has not decreased.

Example 5 includes the subject matter of any of Examples 1-4, and wherein the cluster circuitry is further to (i) determine whether sufficient clusterings have been recorded in response to recordation of the current clustering of the graph and (ii) identify an optimal clustering of the graph based on the cluster quality metric in response to a determination that sufficient clusterings have been recorded.

Example 6 includes the subject matter of any of Examples 1-5, and wherein the deletion circuitry is further to reintroduce the first edge into the graph in response to a determination that the cluster quality metric has decreased; and the centrality circuitry is further to recalculate an approximate vertex centrality weight for each vertex of the graph in response to reintroduction of the first edge into the graph.

Example 7 includes the subject matter of any of Examples 1-6, and wherein the deletion circuitry is further to (i) determine whether a backtrack counter exceeds a predetermined backtrack threshold in response to the determination that the cluster quality metric has decreased and (ii) increment the backtrack counter in response to the reintroduction of the first edge into the graph; and to reintroduce the first edge into the graph further comprises to reintroduce the first edge into the graph in response to a determination that the backtrack counter does not exceed the predetermined backtrack threshold.

Example 8 includes the subject matter of any of Examples 1-7, and wherein to record the cluster quality metric for the current clustering of the graph comprises to record the cluster quality metric for the current clustering of the graph in response to the determination that the cluster quality metric has not decreased or a determination that the backtrack counter exceeds the predetermined backtrack threshold.

Example 9 includes the subject matter of any of Examples 1-8, and wherein the predetermined backtrack threshold comprises ten backtracks.

Example 10 includes the subject matter of any of Examples 1-9, and wherein the cluster quality metric comprises a modularity metric.

Example 11 includes the subject matter of any of Examples 1-10, and wherein the cluster quality metric comprises a modified cluster path length.

Example 12 includes the subject matter of any of Examples 1-11, and wherein to compute the modified cluster path length comprises to weight a ratio of average distance between vertices in the graph and average distance between vertices in a cluster by a number of vertices in the cluster.

Example 13 includes the subject matter of any of Examples 1-12, and wherein to compute the modified cluster path length comprises to compute the modified cluster path length as a function of an edge density of the graph.

Example 14 includes the subject matter of any of Examples 1-13, and wherein to calculate the approximate vertex centrality weight for each vertex of the graph comprises to select a pair of distinct vertices from the graph uniformly at random; compute a set of all shortest paths between the pair of distinct vertices; select a path from the set of all shortest paths uniformly at random; and increment the approximate vertex centrality weight of each interior vertex of the path.

Example 15 includes the subject matter of any of Examples 1-14, and wherein to calculate, based on the approximate vertex centrality weight for each vertex of the graph, the approximate edge centrality value for each edge of the graph comprises to select a pair of distinct vertices from the graph with a probability of each vertex equal to the approximate vertex centrality weight of the corresponding vertex; compute a set of all shortest paths between the pair of distinct vertices; select a path from the set of all shortest paths uniformly at random; and increment the approximate edge centrality value of each edge of the path.

Example 16 includes a method for automatic graph partitioning, the method comprising calculating, by a computing device, an approximate vertex centrality weight for each vertex of a graph; calculating, by the computing device and based on the approximate vertex centrality weight for each vertex of the graph, an approximate edge centrality value for each edge of the graph; deleting, by the computing device, a first edge of the graph, wherein the first edge connects a first vertex and a second vertex, and wherein the first edge has a largest approximate edge centrality value of the edges of the graph; determining, by the computing device, whether the first vertex and the second vertex are connected in the graph subsequent to deleting the first edge; and computing, by the computing device, a cluster quality metric for the graph in response to determining that the first vertex and the second vertex are not connected in the graph subsequent to deleting the first edge.

Example 17 includes the subject matter of Example 16, and further including determining, by the computing device, whether a threshold number of edges have been deleted in response to determining that the first vertex and the second vertex remain connected in the graph; deleting, by the computing device, a second edge of the graph in response to determining that the threshold number of edges have not been deleted, wherein the second edge has a largest approximate edge centrality value of the edges remaining in the graph; and recalculating, by the computing device, an approximate vertex centrality weight for each vertex of the graph in response to determining that the threshold number of edges have been deleted.

Example 18 includes the subject matter of any of Examples 16 and 17, and wherein the threshold number of edges comprises five edges.

Example 19 includes the subject matter of any of Examples 16-18, and further including determining, by the computing device, whether the cluster quality metric has decreased in response to deleting the first edge of the graph; and recording, by the computing device, a current clustering of the graph and the cluster quality metric in response to determining the cluster quality metric has not decreased.

Example 20 includes the subject matter of any of Examples 16-19, and further including determining, by the computing device, whether sufficient clusterings have been recorded in response to recording the current clustering of the graph; and identifying, by the computing device, an optimal clustering of the graph based on the cluster quality metric in response to determining that sufficient clusterings have been recorded.

Example 21 includes the subject matter of any of Examples 16-20, and further including reintroducing, by the computing device, the first edge into the graph in response to determining that the cluster quality metric has decreased; and recalculating, by the computing device, an approximate vertex centrality weight for each vertex of the graph in response to reintroducing the first edge into the graph.

Example 22 includes the subject matter of any of Examples 16-21, and further including determining, by the computing device, whether a backtrack counter exceeds a predetermined backtrack threshold in response to determining that the cluster quality metric has decreased; and incrementing, by the computing device, the backtrack counter in response to reintroducing the first edge into the graph; wherein reintroducing the first edge into the graph further comprises reintroducing the first edge into the graph in response to determining that the backtrack counter does not exceed the predetermined backtrack threshold.

Example 23 includes the subject matter of any of Examples 16-22, and wherein recording the cluster quality metric for the current clustering of the graph comprises recording the cluster quality metric for the current clustering of the graph in response to determining the cluster quality metric has not decreased or determining that the backtrack counter exceeds the predetermined backtrack threshold.

Example 24 includes the subject matter of any of Examples 16-23, and wherein the predetermined backtrack threshold comprises ten backtracks.

Example 25 includes the subject matter of any of Examples 16-24, and wherein computing the cluster quality metric comprises computing a modularity metric.

Example 26 includes the subject matter of any of Examples 16-25, and wherein computing the cluster quality metric comprises computing a modified cluster path length.

Example 27 includes the subject matter of any of Examples 16-26, and wherein computing the modified cluster path length comprises weighting a ratio of average distance between vertices in the graph and average distance between vertices in a cluster by a number of vertices in the cluster.

Example 28 includes the subject matter of any of Examples 16-27, and wherein computing the modified cluster path length comprises computing the modified cluster path length as a function of an edge density of the graph.

Example 29 includes the subject matter of any of Examples 16-28, and wherein calculating the approximate vertex centrality weight for each vertex of the graph comprises selecting a pair of distinct vertices from the graph uniformly at random; computing a set of all shortest paths between the pair of distinct vertices; selecting a path from the set of all shortest paths uniformly at random; and incrementing the approximate vertex centrality weight of each interior vertex of the path.

Example 30 includes the subject matter of any of Examples 16-29, and wherein calculating, based on the approximate vertex centrality weight for each vertex of the graph, the approximate edge centrality value for each edge of the graph comprises selecting a pair of distinct vertices from the graph with a probability of each vertex equal to the approximate vertex centrality weight of the corresponding vertex; computing a set of all shortest paths between the pair of distinct vertices; selecting a path from the set of all shortest paths uniformly at random; and incrementing the approximate edge centrality value of each edge of the path.

Example 31 includes a computing device comprising a processor; and a memory having stored therein a plurality of instructions that when executed by the processor cause the computing device to perform the method of any of Examples 16-30.

Example 32 includes one or more machine readable storage media comprising a plurality of instructions stored thereon that in response to being executed result in a computing device performing the method of any of Examples 16-30.

Example 33 includes a computing device comprising means for performing the method of any of Examples 16-30.

Example 34 includes a computing device for automatic graph partitioning, the computing device comprising means for calculating an approximate vertex centrality weight for each vertex of a graph; means for calculating, based on the approximate vertex centrality weight for each vertex of the graph, an approximate edge centrality value for each edge of the graph; means for deleting a first edge of the graph, wherein the first edge connects a first vertex and a second vertex, and wherein the first edge has a largest approximate edge centrality value of the edges of the graph; means for determining whether the first vertex and the second vertex are connected in the graph subsequent to deleting the first edge; and means for computing a cluster quality metric for the graph in response to determining that the first vertex and the second vertex are not connected in the graph subsequent to deleting the first edge.

Example 35 includes the subject matter of Example 34, and further including means for determining whether a threshold number of edges have been deleted in response to determining that the first vertex and the second vertex remain connected in the graph; means for deleting a second edge of the graph in response to determining that the threshold number of edges have not been deleted, wherein the second edge has a largest approximate edge centrality value of the edges remaining in the graph; and means for recalculating an approximate vertex centrality weight for each vertex of the graph in response to determining that the threshold number of edges have been deleted.

Example 36 includes the subject matter of any of Examples 34 and 35, and wherein the threshold number of edges comprises five edges.

Example 37 includes the subject matter of any of Examples 34-36, and further including means for determining whether the cluster quality metric has decreased in response to deleting the first edge of the graph; and means for recording a current clustering of the graph and the cluster quality metric in response to determining the cluster quality metric has not decreased.

Example 38 includes the subject matter of any of Examples 34-37, and further including means for determining whether sufficient clusterings have been recorded in response to recording the current clustering of the graph; and means for identifying an optimal clustering of the graph based on the cluster quality metric in response to determining that sufficient clusterings have been recorded.

Example 39 includes the subject matter of any of Examples 34-38, and further including means for reintroducing the first edge into the graph in response to determining that the cluster quality metric has decreased; and means for recalculating an approximate vertex centrality weight for each vertex of the graph in response to reintroducing the first edge into the graph.

Example 40 includes the subject matter of any of Examples 34-39, and further including means for determining whether a backtrack counter exceeds a predetermined backtrack threshold in response to determining that the cluster quality metric has decreased; and means for incrementing the backtrack counter in response to reintroducing the first edge into the graph; wherein the means for reintroducing the first edge into the graph further comprises means for reintroducing the first edge into the graph in response to determining that the backtrack counter does not exceed the predetermined backtrack threshold.

Example 41 includes the subject matter of any of Examples 34-40, and wherein the means for recording the cluster quality metric for the current clustering of the graph comprises means for recording the cluster quality metric for the current clustering of the graph in response to determining the cluster quality metric has not decreased or determining that the backtrack counter exceeds the predetermined backtrack threshold.

Example 42 includes the subject matter of any of Examples 34-41, and wherein the predetermined backtrack threshold comprises ten backtracks.

Example 43 includes the subject matter of any of Examples 34-42, and wherein the means for computing the cluster quality metric comprises means for computing a modularity metric.

Example 44 includes the subject matter of any of Examples 34-43, and wherein the means for computing the cluster quality metric comprises means for computing a modified cluster path length.

Example 45 includes the subject matter of any of Examples 34-44, and wherein the means for computing the modified cluster path length comprises means for weighting a ratio of average distance between vertices in the graph and average distance between vertices in a cluster by a number of vertices in the cluster.

Example 46 includes the subject matter of any of Examples 34-45, and wherein the means for computing the modified cluster path length comprises means for computing the modified cluster path length as a function of an edge density of the graph.

Example 47 includes the subject matter of any of Examples 34-46, and wherein the means for calculating the approximate vertex centrality weight for each vertex of the graph comprises means for selecting a pair of distinct vertices from the graph uniformly at random; means for computing a set of all shortest paths between the pair of distinct vertices; means for selecting a path from the set of all shortest paths uniformly at random; and means for incrementing the approximate vertex centrality weight of each interior vertex of the path.

Example 48 includes the subject matter of any of Examples 34-47, and wherein the means for calculating, based on the approximate vertex centrality weight for each vertex of the graph, the approximate edge centrality value for each edge of the graph comprises means for selecting a pair of distinct vertices from the graph with a probability of each vertex equal to the approximate vertex centrality weight of the corresponding vertex; means for computing a set of all shortest paths between the pair of distinct vertices; means for selecting a path from the set of all shortest paths uniformly at random; and means for incrementing the approximate edge centrality value of each edge of the path.

1. A computing device for automatic graph partitioning, the computing device comprising:
centrality circuitry to (i) calculate an approximate vertex centrality weight for each vertex of a graph and (ii) calculate, based on the approximate vertex centrality weight for each vertex of the graph, an approximate edge centrality value for each edge of the graph;
deletion circuitry to (i) delete a first edge of the graph, wherein the first edge connects a first vertex and a second vertex, and wherein the first edge has a largest approximate edge centrality value of the edges of the graph and (ii) determine whether the first vertex and the second vertex are connected in the graph subsequent to deletion of the first edge; and
cluster circuitry to compute a cluster quality metric for the graph in response to a determination that the first vertex and the second vertex are not connected in the graph subsequent to deletion of the first edge.

2. The computing device of claim 1, wherein:
the deletion circuitry is further to (i) determine whether a threshold number of edges have been deleted in response to a determination that the first vertex and the second vertex remain connected in the graph and (ii) delete a second edge of the graph in response to a determination that the threshold number of edges have not been deleted, wherein the second edge has a largest approximate edge centrality value of the edges remaining in the graph; and
the centrality circuitry is further to recalculate an approximate vertex centrality weight for each vertex of the graph in response to a determination that the threshold number of edges have been deleted.

3. The computing device of claim 1, wherein the cluster circuitry is further to (i) determine whether the cluster quality metric has decreased in response to deletion of the first edge of the graph and (ii) record a current clustering of the graph and the cluster quality metric in response to a determination the cluster quality metric has not decreased.

4. The computing device of claim 3, wherein the cluster circuitry is further to (i) determine whether sufficient clusterings have been recorded in response to recordation of the current clustering of the graph and (ii) identify an optimal clustering of the graph based on the cluster quality metric in response to a determination that sufficient clusterings have been recorded.

5. The computing device of claim 3, wherein:
the deletion circuitry is further to reintroduce the first edge into the graph in response to a determination that the cluster quality metric has decreased; and
the centrality circuitry is further to recalculate an approximate vertex centrality weight for each vertex of the graph in response to reintroduction of the first edge into the graph.

6. The computing device of claim 5, wherein:
the deletion circuitry is further to (i) determine whether a backtrack counter exceeds a predetermined backtrack threshold in response to the determination that the cluster quality metric has decreased and (ii) increment the backtrack counter in response to the reintroduction of the first edge into the graph; and
to reintroduce the first edge into the graph further comprises to reintroduce the first edge into the graph in response to a determination that the backtrack counter does not exceed the predetermined backtrack threshold.

7. The computing device of claim 6, wherein to record the cluster quality metric for the current clustering of the graph comprises to record the cluster quality metric for the current clustering of the graph in response to the determination that the cluster quality metric has not decreased or a determination that the backtrack counter exceeds the predetermined backtrack threshold.

8. The computing device of claim 1, wherein the cluster quality metric comprises a modified cluster path length.

9. The computing device of claim 8, wherein to compute the modified cluster path length comprises to weight a ratio of average distance between vertices in the graph and average distance between vertices in a cluster by a number of vertices in the cluster.

10. The computing device of claim 8, wherein to compute the modified cluster path length comprises to compute the modified cluster path length as a function of an edge density of the graph.

11. The computing device of claim 1, wherein to calculate the approximate vertex centrality weight for each vertex of the graph comprises to:
select a pair of distinct vertices from the graph uniformly at random;
compute a set of all shortest paths between the pair of distinct vertices;
select a path from the set of all shortest paths uniformly at random; and
increment the approximate vertex centrality weight of each interior vertex of the path.

12. The computing device of claim 1, wherein to calculate, based on the approximate vertex centrality weight for each vertex of the graph, the approximate edge centrality value for each edge of the graph comprises to:
select a pair of distinct vertices from the graph with a probability of each vertex equal to the approximate vertex centrality weight of the corresponding vertex;
compute a set of all shortest paths between the pair of distinct vertices;
select a path from the set of all shortest paths uniformly at random; and
increment the approximate edge centrality value of each edge of the path.

13. A method for automatic graph partitioning, the method comprising:
calculating, by a computing device, an approximate vertex centrality weight for each vertex of a graph;
calculating, by the computing device and based on the approximate vertex centrality weight for each vertex of the graph, an approximate edge centrality value for each edge of the graph;
deleting, by the computing device, a first edge of the graph, wherein the first edge connects a first vertex and a second vertex, and wherein the first edge has a largest approximate edge centrality value of the edges of the graph;
determining, by the computing device, whether the first vertex and the second vertex are connected in the graph subsequent to deleting the first edge; and
computing, by the computing device, a cluster quality metric for the graph in response to determining that the first vertex and the second vertex are not connected in the graph subsequent to deleting the first edge.

14. The method of claim 13, further comprising:
determining, by the computing device, whether a threshold number of edges have been deleted in response to determining that the first vertex and the second vertex remain connected in the graph;
deleting, by the computing device, a second edge of the graph in response to determining that the threshold number of edges have not been deleted, wherein the second edge has a largest approximate edge centrality value of the edges remaining in the graph; and
recalculating, by the computing device, an approximate vertex centrality weight for each vertex of the graph in response to determining that the threshold number of edges have been deleted.

15. The method of claim 13, further comprising:
determining, by the computing device, whether the cluster quality metric has decreased in response to deleting the first edge of the graph; and
recording, by the computing device, a current clustering of the graph and the cluster quality metric in response to determining the cluster quality metric has not decreased.

16. The method of claim 15, further comprising:
reintroducing, by the computing device, the first edge into the graph in response to determining that the cluster quality metric has decreased; and
recalculating, by the computing device, an approximate vertex centrality weight for each vertex of the graph in response to reintroducing the first edge into the graph.

17. The method of claim 16, further comprising:
determining, by the computing device, whether a backtrack counter exceeds a predetermined backtrack threshold in response to determining that the cluster quality metric has decreased; and
incrementing, by the computing device, the backtrack counter in response to reintroducing the first edge into the graph;
wherein reintroducing the first edge into the graph further comprises reintroducing the first edge into the graph in response to determining that the backtrack counter does not exceed the predetermined backtrack threshold.

18. The method of claim 13, wherein computing the cluster quality metric comprises computing a modified cluster path length.

19. One or more computer-readable storage media comprising a plurality of instructions that in response to being executed cause a computing device to:
calculate an approximate vertex centrality weight for each vertex of a graph;
calculate, based on the approximate vertex centrality weight for each vertex of the graph, an approximate edge centrality value for each edge of the graph;
delete a first edge of the graph, wherein the first edge connects a first vertex and a second vertex, and wherein the first edge has a largest approximate edge centrality value of the edges of the graph;
determine whether the first vertex and the second vertex are connected in the graph subsequent to deleting the first edge; and
compute a cluster quality metric for the graph in response to determining that the first vertex and the second vertex are not connected in the graph subsequent to deleting the first edge.

20. The one or more computer-readable storage media of claim 19, further comprising a plurality of instructions that in response to being executed cause the computing device to:
determine whether a threshold number of edges have been deleted in response to determining that the first vertex and the second vertex remain connected in the graph;
delete a second edge of the graph in response to determining that the threshold number of edges have not been deleted, wherein the second edge has a largest approximate edge centrality value of the edges remaining in the graph; and
recalculate an approximate vertex centrality weight for each vertex of the graph in response to determining that the threshold number of edges have been deleted.

21. The one or more computer-readable storage media of claim 19, further comprising a plurality of instructions that in response to being executed cause the computing device to:
determine whether the cluster quality metric has decreased in response to deleting the first edge of the graph; and
record a current clustering of the graph and the cluster quality metric in response to determining the cluster quality metric has not decreased.

22. The one or more computer-readable storage media of claim 21, further comprising a plurality of instructions that in response to being executed cause the computing device to:
reintroduce the first edge into the graph in response to determining that the cluster quality metric has decreased; and
recalculate an approximate vertex centrality weight for each vertex of the graph in response to reintroducing the first edge into the graph.

23. The one or more computer-readable storage media of claim 22, further comprising a plurality of instructions that in response to being executed cause the computing device to:
determine whether a backtrack counter exceeds a predetermined backtrack threshold in response to determining that the cluster quality metric has decreased; and
increment the backtrack counter in response to reintroducing the first edge into the graph;
wherein to reintroduce the first edge into the graph further comprises to reintroduce the first edge into the graph in response to determining that the backtrack counter does not exceed the predetermined backtrack threshold.

24. The one or more computer-readable storage media of claim 19, wherein to compute the cluster quality metric comprises to compute a modified cluster path length.
